(19) United States
(12) Patent Application Publication
(10) Pub. No.: US 2014/0016433 A1
(43) Pub. Date: Jan. 16, 2014

(54) METHOD AND APPARATUS FOR GENERATING MICRO BUBBLES IN A FLUID FLOW

(71) Applicants: Peter Douglas Jack, Delta (CA); Nels Robert Ladouceur, Delta (CA)

(72) Inventors: Peter Douglas Jack, Delta (CA); Nels Robert Ladouceur, Delta (CA)

(21) Appl. No.: 13/917,477

(22) Filed: Jun. 13, 2013

Related U.S. Application Data
(63) Continuation-in-part of application No. 12/386,935, filed on Apr. 23, 2009.

(51) Int. Cl. B01F 3/04

(52) U.S. Cl. CPC B01F 3/0446
USPC 366/151.1

(57) ABSTRACT

A method and apparatus for generating micro-bubbles and for mixing and/or blending fluids includes providing a pressurized elongate container, having at least one tube mounted in the container inlet. A pre-mixing chamber feeds into each tube. Each tube is cantilevered from the container inlet and has a fixed internal diameter. The tubes are replaceable so that the length of each tube in the container may be optimized to generate micro-bubbles. Tuning or optimizing of the micro-bubble generating system achieves a required pressure drop to form micro-bubbles of five microns or less, and may form nano-bubbles. An upstream pump pressurizes at least two fluids which feed into the pre-mixing chamber. Pressure from the container outlet may be controlled by a valve. The valve leads to a second container, which may be open to atmospheric pressure.

### CROSS REFERENCE TO RELATED APPLICATION

This application is a continuation-in-part from application Ser. No. 12/386,935, filed Apr. 23, 2009, entitled Method and Apparatus for Mixing and/or Blending Fluids.

### FIELD OF THE INVENTION

The invention relates to a method and apparatus for mixing and/or blending fluids and more specifically to a method and apparatus for generating very fine micro-sized bubbles in a fluid flow.

### BACKGROUND OF THE INVENTION

It is known to use air or gas bubbles to separate particles in a fluid. This method has been used for example in separation of petroleum derivatives, and in separation of sludge from effluent. When separating particles from a fluid flow it has been found that the smaller the bubble, and the more numerous the bubbles, the longer the bubbles are suspended in a fluid, and that these smaller and more numerous bubbles improve flotation of the particles. As the bubbles rise, the particles are attached. The particles are skimmed off once they have risen to the top of the fluid. In the prior art, methods of using flotation to separate particles from a fluid are referred to variously as dissolved air flotation, dissolved gas flotation, and induced air or gas flotation.

It has been found that in some instances the same device used to form micro bubbles may also be used to combine or blend fluids and additionally such blended fluids may result in altered densities to further aid in separation of emulsified fluids. It should be noted that for the purposes of the method and apparatus of the present invention, the term “fluid” or “fluids” may include a gas or a liquid and where a gas may include particles that flow with the gas, and a liquid may include more than one type of liquid. As well, the liquid may include particles. Further, when blending, in some instances the “fluid” may be a dry powder that flows as a liquid. Only the apparatus scale or valve types may be required to change in the event of the mixing or blending of “fluids”.

Accordingly, it is an object of the present invention to provide a method and apparatus that can produce extremely tiny bubbles, advantageously 5 microns or less in diameter; wherein referred to as micro-bubbles.

Another object of the present invention is to provide a method and apparatus that according to alternative embodiments may blend different fluids by using a method of dynamic shearing of one fluid into a second fluid.

Another object of the present invention is to provide for micro-bubble generation for dissolved air or dissolved gas flotation, includes retro-fits of less efficient systems, and to create silky-smooth high viscosity aerated or blended liquids, and/or for solvent extraction for example for treating hydrostatic fracturing flow-back water and oil/water separation, and/or for emulsion breaking for example for treating fracturing flow-back water and oil/water separation for tight emulsions, and/or for aiding in reducing dissolved biochemical oxygen demand (BOD) or chemical oxygen demand (COD), and/or for assisting in the dissolution of ozone in water.

### SUMMARY OF THE INVENTION

The method and apparatus described herein for generating micro-bubbles and for mixing and/or blending fluids is capable of functioning within many different applications. In general the process includes providing a pressurized container, wherein the container has an inlet and an outlet. A “stinger” tube is mounted in the inlet. The stinger tube is a slender cylindrical tube having a fixed internal diameter for a fixed flow rate. The tubes are referred to as stinger tubes as they are cantilevered from the inlet into the container. The stinger tubes are inter-changeable so that the length of the tube in the container may be adjusted, for example when the system is tuned upon set-up to optimize the generation of micro-bubbles, as discussed in more detail below. The tuning or optimizing of the system is to achieve the required pressure drop and the formation of micro-bubbles of 5 micron or less for a particular flow rate. Pressure from the container outlet is generally controlled by a valve. The valve leads to a second container. The second container may be open to atmospheric pressure.

The distal end of the tube, distal from the container inlet, is referred to as the nozzle. The nozzle may be for example blunt, squared-off, or chamfered.

As mentioned above, micro bubbles, are useful for particle flotation, for example in dissolved gas flotation or dissolved air flotation systems. An optimized pressure drop across the inlet and tube generates micro-bubbles in the flow leaving the tube nozzle, and causes the fluids to dynamically commingle. In some applications the fluids are air and water wherein the water contains particles for separation and air is introduced upstream of the container inlet, for example, upstream of the device used to pressurize the flow entering the tube. That pressure is the inlet pressure. A pressure drop of 60-90% of the container inlet pressure may be adjusted to produce micro-bubbles so as to enhance the separation process by producing a smooth texture, high-viscosity aerated or otherwise blended liquid. Conventionally, using slender, modified hydrocyclones, a micro-bubble size of five microns has been established where the bubble rise rate in potable water at substantially standard temperature and pressure (STP) is 4 inches per minute. The smaller the micro-bubble size, the slower the rise rate. Consequently, as used herein, a micro-bubble size of five microns or less is considered established when the bubble rise rate is substantially three inches per minute or less. A measured bubble rise rate of substantially three inches per minute or less at STP is thus taken as determinative of a micro-bubble size of 5 microns or less. The outlet pressure is controlled by a downstream valve. The downstream valve leads to another container, which may in one embodiment be open to atmospheric pressure and may include a mechanical skimmer to separate off the floating particles, usually as a scum or sludge.

The first container may include a bleeder valve, for example positioned on the top of the container for relief of excess air or gas pressure build-up in the container. Pressure relief may be done manually or automatically with the use of a conventional auto-bleed valve.

It should be noted that in some instances three or more fluids, which may or may not be soluble, may be commingled, blended, mixed and/or dissolved in whole or in part into each other. This may be done for the following purposes: separation of suspended solids by flotation; or blending two or more fluids into a homogeneous mixture; or aerating a fluid or multiple fluids to increase the total volume; or to change the density; or to provide for an efficient method of pressurized oxidation and/or disinfection of a pathogen laden material by use of a gas such as ozone; or for the treatment of flow-back water including oil/water separation in hydrostatic fracturing of geological structures in the oil and gas industry.

In another embodiment described herein, the outlet flow from the first container flows into the inlet of a second container. A secondary process in the second container duplicates the first process in the first container. The second container duplicates the stinger tube structure of the first container and includes a second outlet where the fluids exit the second container, where-after the flow may be returned to atmospheric pressure.

An optional diffuser plate may be mounted adjacent the distal end of each stinger tube to aid in diffusing of certain types of fluids for mixing and/or blending as desired.

In summary, the method according to one aspect of the present invention for generating micro bubbles of substantially five microns or less in a fluid flow may be characterized as including:
a) providing a micro-bubble generator having:
   (i) a first conduit having an upstream end and an opposite downstream end, wherein the upstream end is in fluid communication with a primary fluid source,
   (ii) a multi-phase pump mounted in fluid communication with the first conduit along the upstream end of the first conduit,
   (iii) a pressure container having a container inlet and a container outlet and having a container cavity therein in fluid communication with the container inlet and the container outlet,
   (iv) a tube having continuous, non-perforated walls and a substantially constant internal diameter, wherein the tube has a tube length and a tube diameter, and opposite upstream and downstream tube ends, the upstream tube end releasably mounted in a fluid-tight seal in the container inlet so as to extend the tube cantilevered into and along the cavity within the pressure container, wherein the tube does not include a flow restrictor restricting flow of a fluid through the tube, the upstream tube end of the tube in fluid communication with the first conduit at the downstream end of the first conduit, and wherein the preferred embodiment the upstream tube end cooperates so as to be in fluid communication with an enlarged primary mixing chamber having a diameter, as measured laterally across the primary or longitudinal direction of the flow, which is greater than a corresponding diameter across the tube, wherein said mixing chamber is immediately upstream of the upstream tube end and in fluid communication with the downstream end of the first conduit,
   (v) a gas or second fluid source mounted to, for supply of gas or second fluid into the first conduit, upstream of the pump and/or upstream of the container inlet, in the latter preferably substantially immediately upstream of the container Melt,
   (vi) a second conduit mounted to the container outlet,
   (vii) a pressure regulator mounted in fluid communication with the second conduit,
b) supplying a primary fluid from the primary fluid source through the first conduit and supplying a gas or secondary fluid from the gas or secondary fluid source so as to supply a combined flow of the primary fluid and the gas or secondary fluid into the suction side of the pump and/or pressurized gas or secondary fluid into the discharge from the pump,
c) pressurizing the combined flow by the pump to a first fluid pressure and into the downstream end of the first conduit so as to urge the combined flow into the enlarged primary mixing chamber and through the tube, and into and through the container cavity so that the combined flow exits out of the container outlet,
d) measuring a second fluid pressure of the combined flow downstream of the downstream tube end of the tube,
e) adjusting the pressure regulator, the pump, and the tube to provide a pressure differential between said first and second fluid pressures, wherein the first fluid pressure is within a range of substantially 50-150 psig and the second pressure is within the range of substantially 60-90 percent of the first fluid pressure, to thereby generate micro-bubbles in the combined flow downstream of the downstream tube end, and wherein the adjusting step includes adjusting at least one of the group comprising:
   (i) the first fluid flow of the combined flow by adjusting the pump,
   (ii) the second fluid pressure of the combined flow by adjusting the pressure regulator,
   (iii) the pressure differential by adjusting the length of the tube,
   (iv) the pressure differential by adjusting the internal diameter of the tube by substituting a first tube for a second tube having a different internal diameter,
   wherein, in step (e)(iii) above, lengthening the length of the tube increases the pressure differential and shortening the length of the tube decreases the pressure differential, and, wherein in step (e)(iv) above, increasing the internal diameter decreases the pressure differential and decreasing the internal diameter increases the pressure differential,
f) Determining, for example by micro-bubble rise rate, if the micro-bubbles generated in step (e) have a diameter which is less than or substantially equal to five microns, for example thus equating to a bubble rise rate of substantially three inches or less per minute,
g) if in the determination in step (f) the micro-bubbles are not the diameter of less than or substantially equal to five microns, then increasing the pressure differential within the ranges in step (e) by further adjusting the pressure regulator and/or by adjusting the tube length and/or the tube diameter of the tube, and then repeating steps (f) and (g) until the micro-bubbles are determined to be diameter of less than or substantially equal to five microns.

### BRIEF DESCRIPTION OF THE DRAWINGS

In the accompanying drawings, in which like reference characters designate the same or similar parts throughout the several views:

FIG. 1 is a partial schematic and cutaway view of one embodiment of a micro-bubble generating system.

FIG. 2 is a further embodiment, in a partially schematic cut-away view, of a micro-bubble generating system.

FIG. 3 is the view of FIG. 1 wherein the stinger tube has a chamfered end.

FIG. 4 is a cutaway view of an alternative embodiment employing a two container micro-bubble generation system.

FIG. 5 is the micro-bubble generating system of FIG. 3 employing a diffuser plate adjacent the downstream end of the stinger tube.

FIG. 6 is, in side elevation view, an alternation embodiment of the mixing pressure container of FIG. 2.

FIG. 6a is a section view along line 6a-6a in FIG. 6.

FIG. 7 is a chart of measured turbidity levels over time caused by suspension of nano-bubbles formed by the micro bubble generator.

### DETAILED DESCRIPTION OF EMBODIMENTS OF THE INVENTION

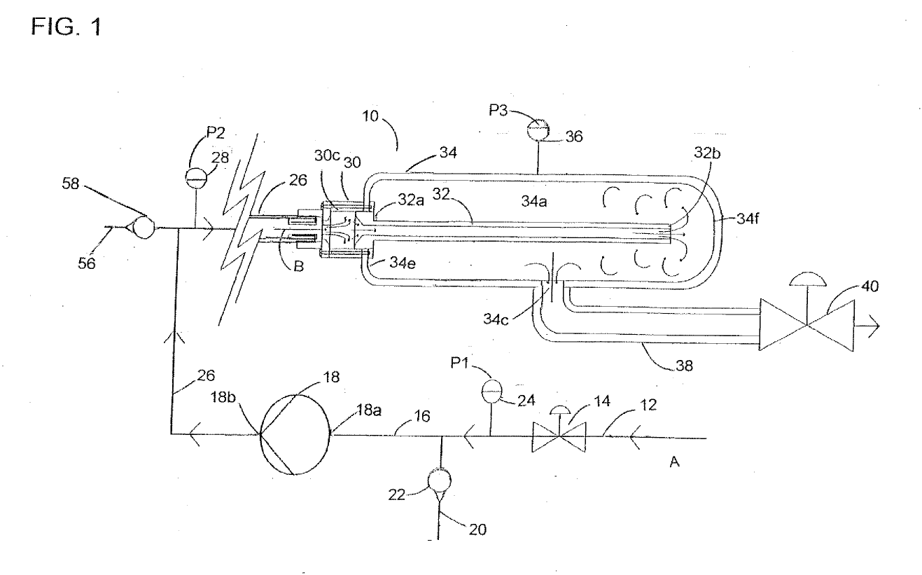

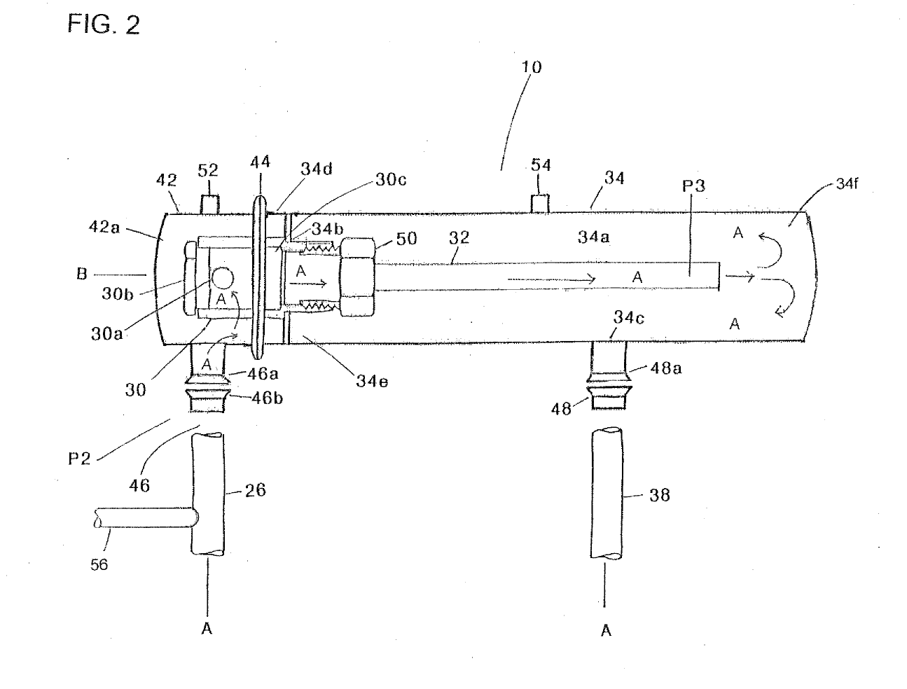

In apparatus 10, as shown by way of example in FIGS. 1 and 2, one or more fluids in conduit 12 flow in direction A, wherein direction. A is indicated by arrow-heads along the flow path. As seen in FIG. 1, flow in conduit 12 flows through a pressure control valve 14, and through conduit 16 into the suction side 18a of a multiphase pump 18. A gas or further fluid is introduced into conduit 16 via conduit 20. Conduit 20 may include a flow indicator 22. A pressure gauge 24 on conduit 16 indicates the fluid pressure (pressure P1) in conduit 16. Pressurized fluid, or a mix of pressurized fluid and gas, leaves pressure side 18b of pump 18 so as to flow along conduit 26, past pressure gauge 28, and into hollow insert 30. Pressure gauge 28 measures fluid pressure (pressure P2) in conduit 26. The pressurized fluid, or the mix of pressurized fluid and gas, flows from insert 30 into and along stinger tube 32, that is, from the upstream end 32a of tube 32 so as to exit from the down-stream end 32b into the cavity 34a of container or vessel 34. The pressure P3 within vessel 34 is indicated by pressure gauge 36. The fluid, or mix of fluid and gas, exits from downstream end 32b of tube 32 into cavity 34a wherein it is turbulently mixed. Hollow insert 30 is mounted into inlet aperture 34b in vessel 34. The contents of cavity 34a exit via outlet 34c so as to flow through conduit 38 and pressure control valve 40.

The suction side 18a of multi-phase pump 18 is held at a fixed pressure below atmospheric pressure so that no compressor or additional pump is required in order to introduce secondary flow into conduit 16 from conduit 20. The use of a multi-phase pump in the flow path is advantageous because such pumps operate without cavitation and at relatively good efficiency. Two types of multi-phase pumps may be used. One is a two stage progressing cavity pump which will pump a liquid and an adequate amount of gas without cavitating, but does little to contribute to aiding in generation of micro-bubbles. The other is a regenerative turbine pump which does not cavitate and aids in the generation of micro-bubbles when up to 15% volume of gas at standard temperature and pressure (“STP”) is added via conduit 20 at the suction side conduit 16 along with the fluid. The fluid is usually, but not always, water. The use of a regenerative turbine pump has its drawbacks however. Because of the tight tolerances in a regenerative turbine pump, it cannot pump fluid having entrained particles without the risk of it seizing. It does however assist with generation of micro-bubbles by creating bubbles down to about 30-40 microns thereby leaving less work for the downstream micro-bubble generation system described herein, which produces micro-bubbles of 5 microns or less.

As shown in the embodiment of FIG. 2, instead of conduit 26 being in-line with insert 30 for axial flow therethrough along the central axis or axis of symmetry B of insert 30 as seen in FIG. 1, insert 30 may be contained within a sealed head 42, itself detachably mounted to vessel 34 around rim 34d by clamp 44. Head 42 has an inlet 46 which includes a tubing nozzle 46a having a clamp 46b and corresponding ferule. Inlet 46 is at right angles to axis B of insert 30. Insert 30 has an inlet 30a adjacent its threaded end plug 30b. Inlet 30a is also at right angles to axis B. As seen in the illustrated embodiment of FIG. 2, inlet 46 and inlet 30a may also be perpendicular to each another. Consequently, fluid entering inlet 46 from conduit 26 has to turn within the cavity 42a of head 42 in order to enter insert 30 through inlet 30a, and then turn again in order to flow along axis B through the mixing chamber 30c of insert 30 so as to enter tube 32.

The hollow cavity within insert 30 provides primary mixing chamber 30c, wherein the diameter of the mixing chamber is greater than the diameter of tube 32. The combined flow flows from the inlet orifice 30a of insert 30, mixes in mixing chamber 30c and flows into the upstream end of tube 32. In the illustrated embodiment of FIG. 2, the inlet 46 into the container head 42 is oriented 90 degrees from the inlet orifice 30a on insert 30 so that the combined flow must turn 90 degrees to enter the insert 30. Such an angular offset, although not necessarily 90 degrees is advantageous. The container outlet 34c may be on a sidewall of the container. Outlet 34c is advantageously located part-way along the container sidewall so that the combined flow, once it leaves the downstream end 32b of the tube 32, must reverse upon itself after it impacts the downstream-most end 34f of the container cavity 34a, that is, reverse its flow direction along the cavity 34a so as to exit from the cavity through the container outlet 34c. This induces further turbulent mixing of the combined flow.

Insert 30 is rigidly mounted into aperture 34b in bulkhead 34e so as to support tube 32 cantilevered into and centrally along cavity 34a, which is advantageously elongate. Tube 32 may be for example ¼ inch, ⅜ inch or ½ inch stainless steel tubing which may be approximately 20 inches long, subject to the length adjustment discussed below. The combined length of vessel 34 and head 42 may be in the order of 24 to 30 inches, and the diameter of vessel 34 may be in the order of 3 inches. Outlet 34c may include nozzle 48 having a clamp 48a and corresponding ferule. Flow exiting cavity 34a flows through nozzle 48 into conduit 38. Tube 32 may be releasably mounted to insert 30 by conventional means known in the art, for example by the threaded coupling 50 illustrated. The illustrated female NPT ports 52 and 54 may be used for mounting, respectively, pressure gauge 28 to head 42 and pressure gauge 36 to vessel 34.

The stream of gas or gases and/or fluid or fluids moving via conduit 20 into conduit 16 may be naturally aspirated into the primary stream in conduit 16, for example between pressure control valve 14 and multi-phase pump 18, at a controlled flow rate. If a gas is being aspirated via conduit 20 into the primary stream in conduit 16, the flow rate ordinarily should not exceed 20 percent by volume of the primary stream. The discharge pressure (pressure P2) of multi-phase pump 18 is advantageously maintained at a pressure ranging from 50 pounds per square inch-gauge (PSIG) to 150 PSTG. This pressure is controlled by the pump settings and valve 40.

In an alternative embodiment, further gas or gases and/or further fluid or fluids may be injected into the primary stream in conduit 26 via conduit 56, and flowing through flow indicator 58, instead of, or in conjunction with the aspirated stream from conduit 20 into conduit 16 at the suction side 18a of multi-phase pump 18.

Within mixing chamber 30c a slight pressure drop creates turbulence for the primary mixing process. Additional pressure drop is realized in tube 32 and in the mixing zone within cavity 34a where turbulence is created between downstream end 32b of tube 32 and the downstream end 34f of container 34. The pressure in the container cavity 34a will advantageously be from 60-90 percent of pressure P2. Consequently pressure P3 may be in the range of 30 to 135 PSIG, wherein the lowest pressure of 30 PSIG is determined as 60 percent of 50 PSIG and the highest pressure of 135 PSIG is determined as 90 percent of 150 PSIG. This pressure differential between pressure P2 and pressure P3 provides the energy for the mixing and blending. The pressure differential between pressure P2 and pressure P3 will determine the degree of mixing and/or bubble size in flow downstream of outlet 34c as adjusted according to the method described herein.

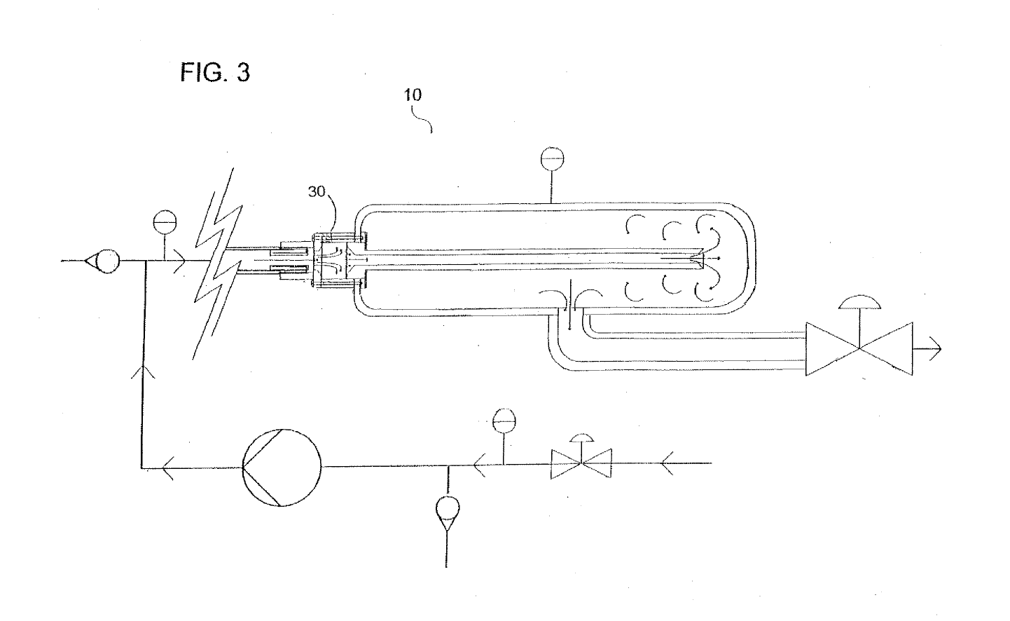

As seen in FIG. 3 the downstream end 32b of tube 32 may be chamfered on the inside edge.

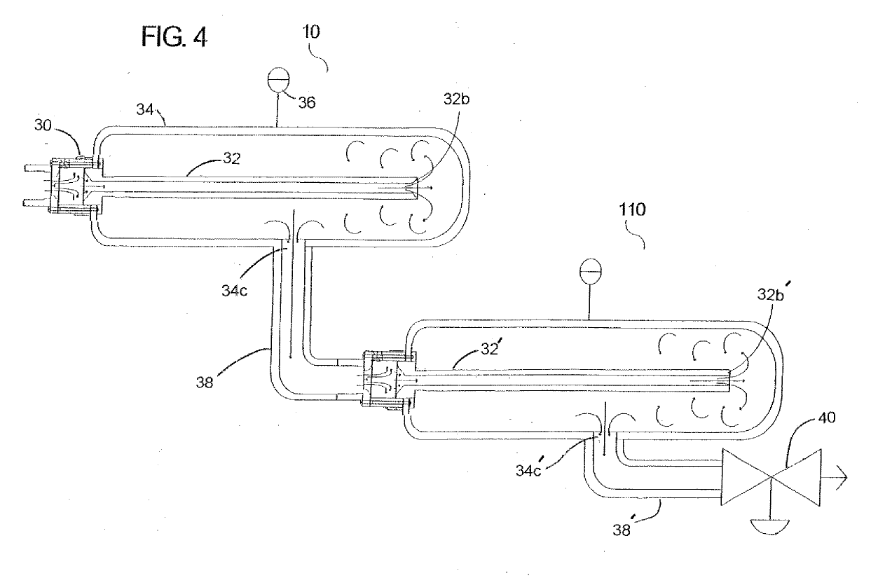

As seen in FIG. 4 a second mixing apparatus 110, which maybe substantially identical to that of mixing apparatus 10, is mounted to conduit 38 downstream of mixing apparatus 10. Within apparatus 110 ends 32b′ of tubes 32′ may be chamfered or blunt. Flow exits via outlet 34c′ and conduit 38′.

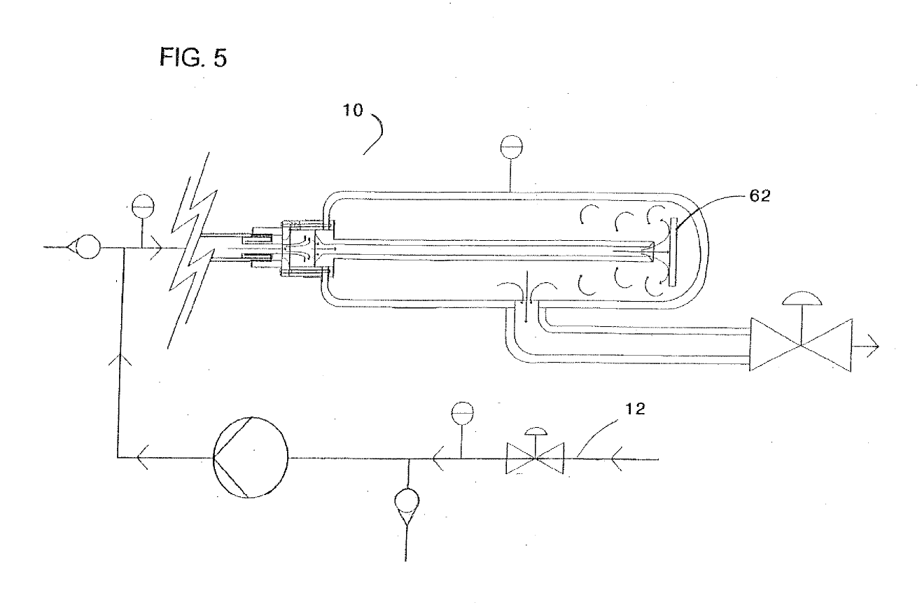

As seen in FIG. 5 an optional diffuser plate 62 may be mounted adjacent the end 32b of tube 32, sandwiched or inter-leaved, at right-angles to the direction of flow A leaving tube 32, between end 32b and end 34f to assist in mixing and/or blending of some fluids for example by increasing turbulent mixing and increasing the pressure drop.

In embodiments of the invention the inlet pressure (pressure P2) downstream of the multi-phase pump 18 may be in the range of 80-150 PSIG. For example, the inlet pressure P2 of the combined flow in direction A in the configuration of FIG. 2 may be 125 PSIG, wherein it is understood that by combined flow what is meant is the combination of the fluid from conduit 12 passing through valve 14, combined with the gas or fluid passing through conduit 20 and into conduit 16 so as to combine and enter into the suction side 18a of multi-phase pump 18, and/or combined with the gas or fluid passing through conduit 56 and into conduit 26 so as to combine downstream, of the downstream side 18b of pumps 18.

As discussed above, in the embodiment of FIG. 2, tube 32 may be for example ¼, ⅜ or ½ inch diameter stainless steel tubing, which is for example 20 inches long. As before, the tube is non-perforated and of a constant un-interrupted internal diameter so that it does not present a flow restrictor. The tube itself is of narrower diameter than mixing chamber 30c of insert 30 which is rigidly mounted through bulkhead 34e of container 34. The container mixing cavity 34a is longer than the length of tube 32. With the insert 30 mounted centered in the bulkhead 34e, and with the tube 32 mounted at its upstream end 32a so as to be centered in the downstream end of insert 30, tube 32 is suspended cantilevered in and along centered in cavity 34a in container 34.

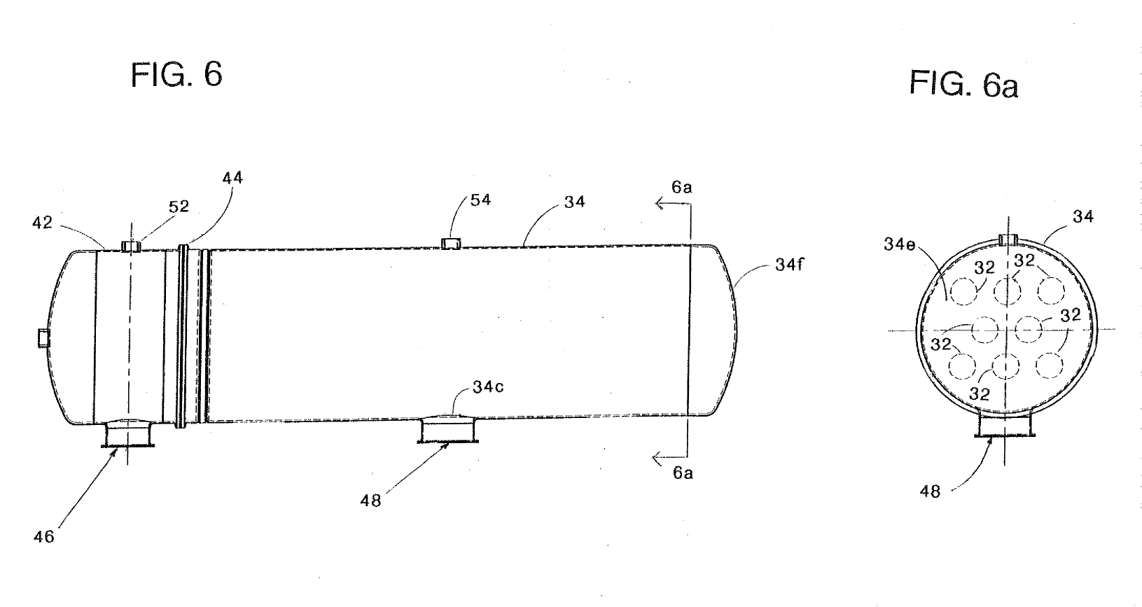

In the alternative embodiment of FIG. 6a eight tubes 32 are shown by way of example, which is not intended to limiting. The eight tubes 32 are mounted in parallel, spaced-apart array within container 34 with their upstream ends in fluid communication with the mixing chamber 30c of insert 30 mounted within head 42 and within their downstream ends terminating short of downstream end 34f. the number of tubes 32 in the array, in conjunction with their diameter (which may be different as between various tubes in the array), is adjusted to produce the desired flow rate and pressure drop so as to generate micro-bubbles of substantially 5 microns or less. Such a pressure vessel containing eight elements or tubes may provide a through-put of 120 gallons per minute (that is, 15 gallons per minute for each apparatus 10), wherein the only constantly moving machinery is the multiphase pump 18. One design consideration in the number of tubes 32 used is the cost and configuration. It may be more economical to use multiple vessels, i.e. vessel 34 within apparatus 10, with fewer tubes 32 in each vessel 34. it may also be more desirable to use multiple vessels 34 when multiple pumps 18 are being used for added control over the flow rate.

Thus although the primary mixing in mixing chamber 30c and the secondary mixing in cavity 34a is important, it is the formation of micro-bubbles of substantially 5 micron diameter or less which is most important for the combined flow to be separated—for example so as to break emulsions or for example to separate the following: solid particle impurities from fluid, oil from fluid such as water, or hydro-carbons from water such as in a hydrostatic fracturing process as described below.

The combined flow is separated downstream in for example a separation chamber wherein the micro bubbles form a very smooth textured foam or blend which slowly rises, at substantially three inches or less in a minute indicating optimized micro-bubbles, to form a sludge or scum which may then be skimmed off. A micro-bubble size of substantially 5 microns or less operates far more effectively in such applications than the use of conventional bubbles such as those of 30 microns in size or so.

During initial set-up, or during maintenance, the system described above is adjusted or tuned to optimize the generation of the 5 micron micro-bubbles. For a given flow rate, a larger internal diameter for tube 32 will result in larger bubble size because of lower differential pressure across the vessel 34. If during operation, larger bubbles are desired, shortening the tube length achieves the same results and saves times as well. If the flow rate is decreased but the same inlet pressure is maintained, differential pressure is reduced and larger bubble size will result. These operational decisions and priorities are adjusted and optimized for the conditions present.

Micro bubbles of five microns or less have been found to occur under a favourable pressure differential measured across insert 30 and tube 32 (for example, P3-P2), in the range of a 20-50 PSIG, and preferably a 30-40 PSIG, pressure drop. Pressure P2 may be regulated by regulating valve 14 and/or and may be adjusted by multi-phase pump 18. Pressure P3 is regulated using valve 40 and/or by adjusting the length and/or diameter of tube 32. That is the pressure drop P3-P2, for example, shortening (by cutting or replacing) or lengthening the length of tube 32 and/or by adjusting the size of the internal diameter of tube 32. Thus, tube 32 may be cut-down to reduce its length, or swapped for another tube of different length and/or diameter, for example ¼, ⅜ or ½ inch. The longer the tube and/or the narrower the tube, the greater the pressure drop P3-P2. Thus in the illustrated example of FIG. 1a, a 45 PSIG pressure drop was obtained using an inlet pressure (pressure P2) of 125 PSIG and a 20 inch long, ⅜ inch diameter tube 32. Only larger, inferior bubbles are formed if the pressure differential P3-P2 is of too low a magnitude. With micro-bubbles of 5 microns or less formed according to the present invention, aerated water will look like milk or cream with a bubble rise rate of substantially three inches or less of vertical rise per minute.

If, upon checking, the size of the micro-bubbles being generated is greater than 5 microns, for example if the bubbles rise to quickly, or are individually visible to the un-aided eye, then an installer or person maintaining the system may check the system operation and components according to the following hierarchy:
1. First, the air flow rate may be checked. If the air flow rate is too high, that is, if it exceeds 15 percent by volume at STP, then there will not be proper mixing and the micro-bubbles will be too large. For example the suction side of the pump may be checked to make sure it is producing 5-10 inches of mercury suction to draw in adequate amount of air.
2. Second, the pump discharge pressure and the overall pressure drop may be checked. If the pump discharge pressure is within the range of 80-150 psig, then check that the pressure drop is sufficient (as set out herein), and if it is neither too high or too low then adjust the flow rate in the micro-bubble generator system (for example, adjust the pump) or change the pressure set point in the valve 40 downstream of the container 34.
3. Third, if the pressure drop is still insufficient modify the stinger tube arrangement (for example, reduce the tube diameter or lengthen the tube, or increase the number of tubes while maintaining the same flow rate)

Thus as will now be understood by those skilled in the art, each apparatus 10 utilizes pressure differential P3-P2 and turbulence to generate two or more high velocity zones, and two or more mixing zones for intimate mixing, blending and/or dissolution of usually two or more dissimilar feeds. To recap, and with reference to FIG. 2 in particular:

(a) aerated water or two or more different liquids enter apparatus 10 at a pressure usually ranging from 80 PSIG to 150 PSIG. If air or gas is used with water, the ratio of gas to air is typically from 10 to 15% by volume at STP.

(b) the combined flow accelerates as it passes through the inlet 46 and inlet 30a, which are both perpendicular to the direction B of flow through the length of the insert 30, resulting in high turbulence and thorough mixing.

(c) as the internal diameter of insert 30 reduces in flow direction B more intimate mixing occurs before the combined flow enters the tubular section (tube 32) downstream of the insert cavity 30c.

(d) additional mixing takes place in tube 32 and in cavity 34a, in particular in cavity 34a adjacent end 34f, so that the overall pressure drop between P2 and P3 is generally between 20 and 50 PSIG.

(e) the outlet 34c is directed to a pressure control valve 40 where-after the downstream pressure (downstream of valve 40) is usually reduced to near atmospheric pressure. At this point micro-bubbles of typically 5 microns or less are formed.

It was observed that during operation of the micro-bubble generating apparatus (MBG) 10 that turbidity increased indicating the presence of nano-bubbles. In particular it was observed that nano-bubbles formed and remained in suspension in clean tap water for 10 or more minutes. The following experiment was conducted:

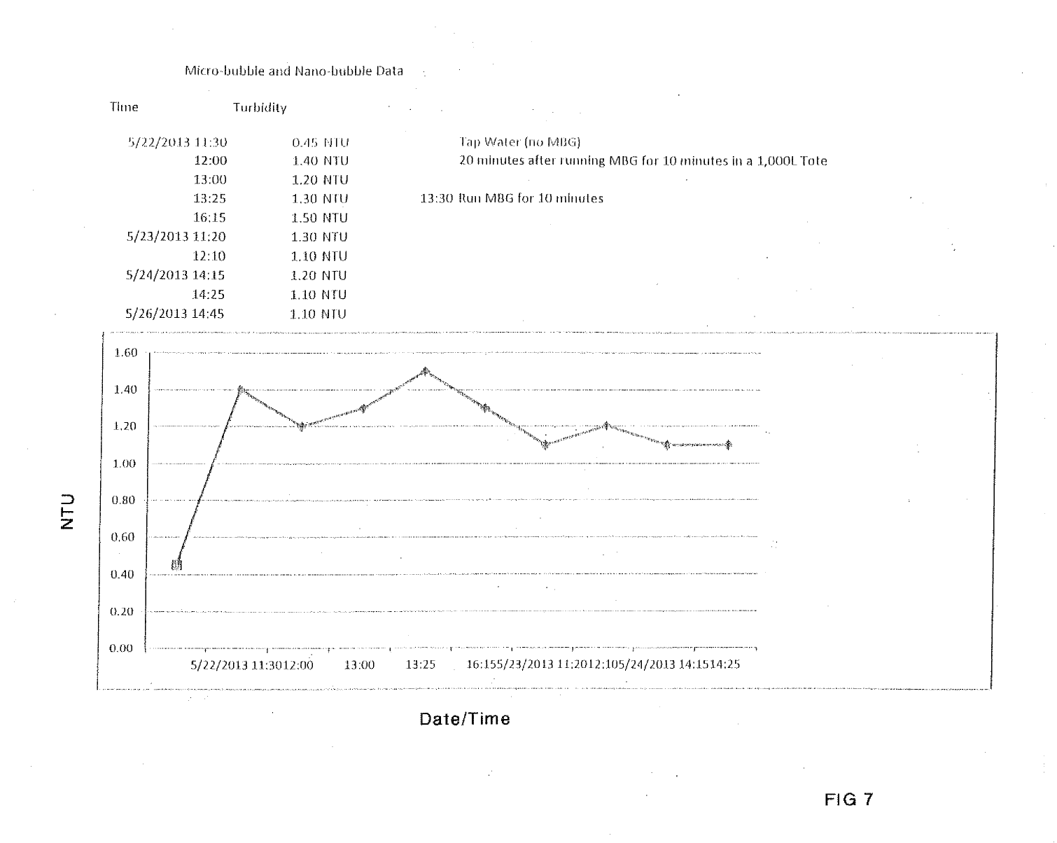

A 1000 liter tote was filled with clean tap water and the turbidity was checked. The turbidity was 0.45 Nephelometric Turbidity Units (NTU). The apparatus 10 was run at 8-10 gallons per minute (GPM), circulating in the tote for 10 minutes. The water cleared in 10 minutes and the turbidity was checked again and found to be up to 1.40 NTU. After 1-1½ hours, apparatus 10 was run again for an additional 10 minutes which brought the turbidity from about 1.30 NTU to about 1.50 NTU. As seen in the chart of FIG. 7, the turbidity was still at 1.20 NTU after four days. This indicated that although the water looked perfectly clear, there was still evidence that invisible to the eye, nano-bubbles were held in suspension for an extended period of time. A turbidity meter, that detects light scattering, measured scattering caused by the nano-bubbles.

In many industries it is beneficial to introduce not only micro-bubbles (i.e. in the order of 10⁻⁶ m), but also to introduce nano-bubbles (i.e. in the order of 10⁻⁹ m), where extended contact of gases in water or other fluids is desirable. For example, in bioreactors extended contact with oxygen or carbon dioxide is desirable. In algae farming extended contact with carbon dioxide is desirable. In agriculture extended oxygen contact for plants is desirable. In aquaculture maintaining a high dissolved oxygen content in water (for fish and aquatic life) is desirable. In disinfection extended contact with ozone (for more efficient mass transfer) is desirable. In preservatives to kill or deactivate microorganisms residing on the surface of fruits and vegetables maintaining a high dissolved ozone concentration as an example is desirable. In drinking water and other drinking fluids, providing a higher dissolved oxygen content is desirable.

The apparatus 10 may, as mentioned above, be used to treat hydrostatic fracturing flow-back water produced during the hydrostatic fracturing process wherein geological structures are fractured to release hydrocarbons. The flow-back water contains considerable silt, sand, hydrocarbons and other material entrained in the flow-back water. Depending on the geological formation being fractured and the type of hydrocarbon production to be increased, the entrained material will differ.

In most cases sand, silt and hydrocarbons with varying densities will be part of the flow-back. Sand being the most dense will fairly easily drop out of the flow-back in settling tanks if there is adequate retention time. Emulsified hydrocarbons and oil wetted suspended solids can be difficult to separate. Heat and chemicals are often used. However, chemicals and heat energy requirements make this option expensive.

Once the heavier solids have dropped out, the apparatus 10 may be used to separate suspended solids and emulsified hydrocarbons from water. In this case air is not used for creating micro-bubbles. Instead a hydrocarbon gas such as CH₄ (methane), C₂H₆ (ethane), C₃H₈ (propane) or C₄H₁₀ (butane) can be used. These gases will contact and be dissolved in the usually heavier emulsified hydrocarbon that needs to be separated from the water. The emulsified hydrocarbon density will be lowered allowing it to become “free oil” that can be readily skimmed from the surface of the water. Oil wetted solids will be contacted by the micro-bubbles of gas and be lifted to the surface as well.

Light hydrocarbon liquids such as C₅H₁₂ (pentane) which is similar to conventional gasoline, can be used in the same manner. In this case the light hydrocarbon liquid will thoroughly contact the heavier emulsified hydrocarbon and oil wetted solids. The lower density overall will allow the solids and hydrocarbons to float to the water surface for skimming. In either case the apparatus 10 may be used equally as well and provide the desired results more efficiently and more economically.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

It is intended that the scope of the invention be defined by the Claims appended hereto and their equivalents.

What is claimed is:

1. A method for generating micro bubbles of substantially five microns or less in a fluid flow, the method comprising:
a) providing a micro-bubble generator having:
(i) a first conduit having an upstream end and an opposite downstream end, wherein said upstream end is in fluid communication with a primary fluid source,
(ii) a multi-phase pump mounted in fluid communication with said first conduit along said upstream end of said first conduit,
(iii) a pressure container having a container inlet and a container outlet and having a container cavity therein in fluid communication with said container inlet and said container outlet,
(iv) a tube having continuous, non-perforated walls and a substantially constant internal diameter, wherein said tube has a tube length and a tube diameter, and opposite upstream and downstream tube ends, said upstream tube end mounted in a fluid-tight seal in said container inlet, so as to extend said tube cantilevered into and along said cavity within said pressure container, wherein said tube does not include a flow restrictor restricting flow of a fluid through said tube, said upstream tube end of said tube in fluid communication with said first conduit at said downstream end of said first conduit, and further comprising a primary mixing chamber upstream of and in fluid communication with said upstream tube end wherein said primary mixing chamber has an internal diameter which is larger than said internal diameter of said tube, and wherein said downstream end of said first conduit is in fluid communication with said primary mixing chamber,
(v) a gas or second fluid source mounted to, for supply of gas or second fluid into said first conduit, upstream of said pump,
(vi) a second conduit mounted to said container outlet,
(vii) a pressure regulator mounted in fluid communication with said second conduit,
b) supplying a primary fluid from said primary fluid source through said first conduit and supplying a gas or secondary fluid from said gas or secondary fluid source so as to supply a combined flow of said primary fluid and said gas or secondary fluid into said pump,
c) pressurizing said combined flow by said pump to a first fluid pressure and into said downstream end of said first conduit so as to urge said combined flow into and through said tube, and into and through said container cavity so that said combined flow exits out of said container outlet,
d) measuring a second fluid pressure of said combined flow downstream of said downstream tube end of said tube,
e) adjusting said pressure regulator, said pump, and said tube to provide a pressure differential between said first and second fluid pressures, wherein said first fluid pressure is within a range of substantially 50-150 psig and said second pressure is within the range of substantially 60-90 percent of said first fluid pressure, to thereby generate micro-bubbles in said combined flow downstream of said downstream tube end, and wherein said adjusting step includes adjusting at least one of the group comprising:
(i) said first fluid pressure of said combined flow by adjusting said pump,
(ii) said second fluid pressure of said combined flow by adjusting said pressure regulator,
(iii) said pressure differential by adjusting said length of said tube,
(iv) said pressure differential by adjusting said internal diameter of said tube by substituting a first said tube for a second said tube having a different said internal diameter,
wherein, in step (e)(iii) above, lengthening said length of said tube increases said pressure differential and shortening said length of said tube decreases said pressure differential, and, wherein in step (e)(iv) above, increasing said internal diameter decreases said pressure differential and decreasing said internal diameter increases said pressure differential,
h) determining if said micro-bubbles generated in step (e) have a diameter which is less than or substantially equal to five microns,
i) if in said determination in step (f) said micro-bubbles are not said diameter of less than or substantially equal to five microns, then increasing said pressure differential within said ranges in step (e) by further said adjusting said pressure regulator and/or by adjusting said tube length and/or said tube diameter of said tube, and then repeating steps (f) and (g) until said micro-bubbles are said determined to be said diameter of less than or substantially equal to five microns.

2. The method of claim 1 further comprising providing a plurality of said micro-bubble generators and arranging said plurality of micro-bubble generators substantially in parallel, and wherein each said micro-bubble generator has an individual throughput of said combined flow, and wherein a cumulative throughput, substantially cumulative of said individual throughput of said plurality of said micro-bubble generators, is thereby achieved.

3. The method of claim 2 wherein said step of adjusting said length of said tube includes removing a first said tube and replacing it with a second said tube, wherein one of said first and second tubes has a blunt end at said downstream tube end and the other of said first and second tubes has a chamfered end at said downstream tube end.

4. The method of claim 2 wherein said step of adjusting said length of said tube includes removing a first said tube and replacing it with a second said tube having a different said tube length.

5. The method of claim 4 wherein said step of determining if said micro-bubbles have a diameter which is less than or substantially equal to five microns includes measuring a bubble rise rate of said micro-bubbles and determining if said bubble rise rate is substantially three inches or less per minute.

6. The method of claim 4 further comprising providing an array of different sizes of said tube, and mounting into said fluid-tight seal one said tube of said array corresponding to said tube length and/or tube diameter sufficient to provide said pressure differential to create said micro-bubbles having said diameter of less than or substantially equal to five microns.

7. The method of claim 4 wherein said tube length of said first tube is substantially 20 inches, and wherein said tube diameter of said first tube is substantially in the range of ¼ to ½ inch.

8. The method of claim 7 wherein said container cavity forms a sleeve about said tube.

9. The method of claim 8 wherein said sleeve has a diameter of substantially three inches.

10. The method of claim 4 wherein a hollow insert having said primary mixing chamber therein is mounted in said container inlet, wherein said upstream end of said tube is releasably mounted to said insert in fluid communication with said mixing chamber.

11. The method of claim 10 wherein said mixing chamber is elongate and has a longitudinal axis along a length of said mixing chamber, wherein said tube has a corresponding longitudinal axis which is substantially co-axial with said longitudinal axis of said mixing chamber, and wherein said insert has a mixing chamber inlet directing said combined flow into said mixing chamber at an angle substantially orthogonal to said longitudinal axis of said mixing chamber.

12. The method 11 further comprising providing a head having a flow manifold, and mounting said head over said insert so as to encase said insert in said manifold, and wherein said head has a manifold inlet directing said combined flow from said down-stream end of said first conduit into said manifold substantially orthogonally to both said longitudinal axis of said mixing chamber and said mixing chamber inlet.

13. The method of claim 1 further comprising providing a upstream pressure regulator on said first conduit upstream of said source of gas or secondary fluid.

14. The method of claim 1 wherein said gas or secondary fluid is a gas supplied in a volume which is 15 percent by volume of said conduit flow at standard temperature and pressure conditions.

15. The method of claim 14 wherein said pump is a regenerative turbine pump, and wherein regenerative turbine pump produces bubbles of substantially 30-40 microns into said combined flow to assist in said generation of said micro-bubbles.

16. The method of claim 14 wherein said gas is supplied at ambient pressure by said gas or secondary fluid source.

17. The method of claim 1 wherein said primary fluid is flow back water from hydrostatic fracturing of a geological structure, and wherein said gas or secondary fluid is a hydrocarbon chosen from the group comprising: methane, ethane, propane, butane, pentane.

18. The method of claim 1 wherein said tube is a plurality of tubes.

19. The method of claim 18 wherein said plurality of tubes is a parallel, spaced-apart array of said tubes.

20. The method of claim 19 wherein said array contains at least six said tubes and each said pressure vessel is sized and said flow rate adjusted to produce at least substantially 10 gallons per minute.

21. The method of claim 1 further comprising generating nano-bubbles in said micro-bubble generator simultaneously with said generating of said micro bubbles so as to produce increased turbidity due to said nano-bubbles, and wherein said nano-bubbles stay in suspension longer than said micro-bubbles by at least an order of ten.
